(19) United States
(12) Patent Application Publication
(10) Pub. No.: US 2013/0263152 A1
(43) Pub. Date: Oct. 3, 2013

(54) SYSTEM FOR SCHEDULING THE EXECUTION OF TASKS BASED ON LOGICAL TIME VECTORS

(71) Applicants: Renaud Sirdey, Cernay-la-ville (FR); Vincent David, Marcoussis (FR)

(72) Inventors: Renaud Sirdey, Cernay-la-ville (FR); Vincent David, Marcoussis (FR)

(21) Appl. No.: 13/824,467

(22) PCT Filed: Sep. 21, 2011
(86) PCT No.: PCT/FR11/52176

§ 371 Date: Jun. 21, 2013

(30) Foreign Application Priority Data
Oct. 7, 2010 (FR) 10 03964

(51) Int. Cl. G06F 9/48

(52) U.S. Cl. CPC G06F 9/4837
USPC 718/107

(57) ABSTRACT

A comparator unit for two Nm-bit data words, comprises a comparison output indicative of an order relation between the two data words, the function of the comparison unit being represented by a logic table comprising rows associated with the possible consecutive values of the first data word and columns associated with the possible consecutive values of the second data word, where each row includes a one at the intersection with the column associated with the same value as the row, followed by a series of zeros. The series of zeros is followed by a series of ones completing the row circularly, the number of zeros being the same for each row and smaller than half of the maximum value of the data words.

### CROSS-REFERENCE TO RELATED APPLICATIONS

This application is a Section 371 of International Application No. PCT/FR2011/052176, filed Sep. 21, 2011, which was published in the French language on Apr. 12, 2012, under International Publication No. WO 2012/045942 A1and the disclosure of which is incorporated herein by reference.

### BACKGROUND OF THE INVENTION

1. Field of the Invention

Embodiments of the invention relate to the scheduling of the execution of interdependent tasks in a multi-task system, particularly in the context of the execution of tasks of a dataflow process that may include data-dependent control.

2. Background of the Invention

A recurring problem in multi-tasking is the scheduling of tasks, i.e., the execution of each task at a time when all the conditions for the task are met. These conditions include the availability of data consumed by the task and the availability of space to accommodate the data produced by the task, in the case of dataflow-type processing.

There are various methods for scheduling tasks, for example based on graph construction and navigation. Some methods seek to optimize performance, while others address operational safety. Methods addressing operational safety attempt to reduce or eliminate the occurrence of deadlocks, which happen, for example, in a situation where two tasks cannot execute because the method determines that the execution of each of these tasks depends on the execution of the other task.

U.S. Patent Application Publication No. 2008/0005357 describes a method applicable to dataflow processing for optimizing performance. The method is based on the construction of graphs and token circulation. A task can only be executed if it has a token produced by another task. When the task is executed, the token is passed to the next task. The method is a fairly straightforward implementation of a calculation model that does not take into account constraints that guarantee operational safety.

There is thus a need for a scheduling method having both a good performance and operational safety.

### BRIEF SUMMARY OF THE INVENTION

This need is addressed by a method of execution of several interdependent tasks on a multi-task system, including: associating to each task a logical time vector indicative of the current occurrence of the task and the occurrences of a set of other tasks on which the current occurrence depends; defining a partial order on the set of logical time vectors, such that a first vector is considered greater than a second vector if all components of the first vector are greater or equal to the respective components of the second vector, and at least one component of the first vector is strictly greater than the respective component of the second vector; comparing the logical time vectors according to the partial order relation; executing the task if its logical time vector is not greater than any other of the logical time vectors; and updating the logical time vector of the executed task for a new occurrence of the task, by incrementing at least one component of the vector.

According to an embodiment, the method includes: associating to each task a dependency counter indicative of the number of conditions to be met for executing an occurrence of the task; planning execution of the task when its dependency counter reaches zero; when a task is executed, decrementing the dependency counter of each other task having a logical time vector greater than the logical time vector of the executed task; updating the logical time vector of the executed task; incrementing the dependency counter of the executed task for each other task having a logical time vector smaller than the logical time vector of the executed task; and incrementing the dependency counter of each other task having a logical time vector greater than the logical time vector of the executed task.

According to an embodiment, the logical time vector of a current task includes a component associated with each possible task. The component associated with the current task contains the occurrence number of the current task. A component associated with another task identifies the occurrence of the other task that should be completed before the current task can be executed, a zero component indicating that the current task is not dependent on the task associated with the zero component.

In order to accelerate carrying out of the method, a processor system may include a hardware comparator unit for two Nm-bit data words, including a comparison output indicative of an order relation between the two data words, the function of the comparison unit being represented by a logic table comprising rows associated with the possible consecutive values of the first data word and columns associated with the possible consecutive values of the second data word, where each row includes a one at the intersection with the column associated with the same value as the row, followed by a series of zeros. The series of zeros is followed by a series of ones completing the row circularly, the number of zeros being the same for each row and smaller than half of the maximum value of the data words.

A comparator for two vectors according to a partial order relation, wherein each vector includes components having a number of bits that is a multiple of Nm, includes a plurality of comparator units of the above type, connected in a chain through carry propagation terminals; a gate arranged between the carry propagation terminals of two consecutive units, configured to interrupt the carry propagation between said consecutive units in response to an active state of a signal defining a boundary between vector components; and a gate arranged at the comparison output, configured for inhibiting the state of the comparison output in response to an inactive state of the boundary definition signal.

According to an embodiment, each unit includes an equality output indicative of the equality of the data words presented to the unit, and the comparator includes logic configured to establish an active indication if and only if all comparison outputs of the units are active and the equality output of at least one unit is inactive.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

Other advantages and features will become more clearly apparent from the following description of particular embodiments of the invention provided for exemplary purposes only and represented in the appended drawings, in which:

In the drawings:

FIG. 1 shows a simple example of a succession of tasks to execute in a dataflow process;

FIG. 2 is a graph showing dependencies between different occurrences of each task of FIG. 1;

FIG. 3 corresponds to the graph of FIG. 2, wherein each occurrence of a task is labeled with a logical time vector used to identify the dependencies between task occurrences;

FIG. 4 shows the graph of FIG. 3 with different execution times for some task occurrences;

FIG. 5 shows an example of a sequence of tasks in a dataflow process, with two alternative task executions;

FIG. 6 is a graph wherein occurrences of the tasks of FIG. 5 are labeled with logical time vectors;

FIG. 7 is a graph showing an exemplary execution trace for a processing corresponding to FIG. 5, labeled with logical time vectors and dependency counter values;

FIG. 8 is a graph showing another case of execution trace; and

FIG. 9 schematically shows an embodiment of a comparator for comparing vectors according to a partial order.

### DETAILED DESCRIPTION OF THE INVENTION

To track the conditions that must be met for starting an occurrence of a task in a multi-task system, in particular tasks of a dataflow process, the present disclosure provides to maintain, for each task, a logical time vector that represents the dependencies of the task.

Hereinafter, the term “task” designates a generic set of processing steps. The terminology “execution” of the task, or “occurrence” of the task refers to execution of the task on a specific data set (in dataflow processing, consecutive occurrences of the same task are executed on consecutive data sets of an incoming flow). Logical time vectors are associated with each task and reflect the dependencies of the current occurrence of the task.

Logical time vectors are introduced in the papers “Logical time: capturing causality in distributed systems,” by M. Raynal and M. Singhal (IEEE Computer 29 (2), 1996) and “Logical time in distributed computing systems,” by C. Fidge (IEEE Computer 24 (8), 1991).

Logical time vectors associated with a partial order relation have been used to date events transmitted from one process to another, so that each process that receives events through distinct channels can reorder them causally. In other words, a logical time vector is normally used to identify and relatively date an event in the past.

As will be understood below, logical time vectors are used in this disclosure to determine at what time a task can be executed. In other words, the logical time vectors are used to constrain the execution order of tasks, that is to say, to organize events in the future.

This use of logical time vectors will be described in more detail below with examples of dataflow processes.

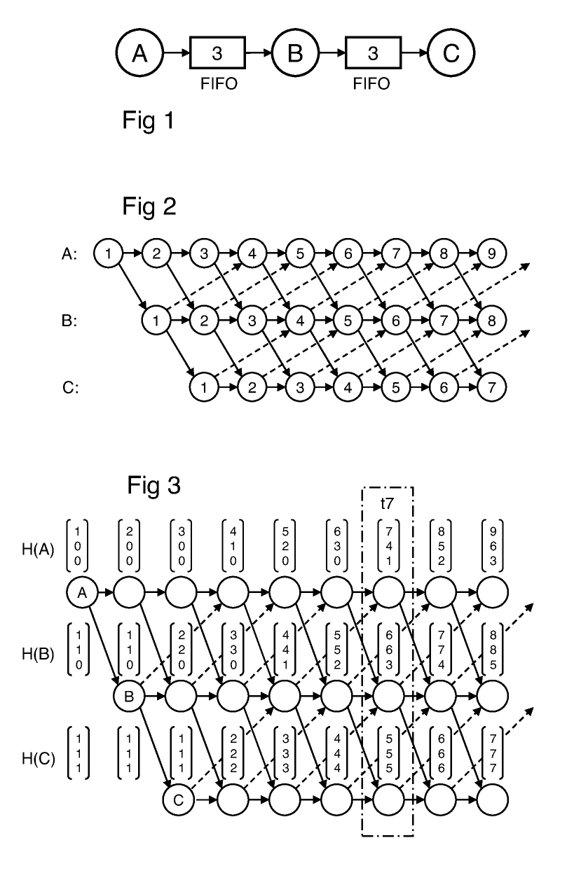

FIG. 1 represents an elementary dataflow process. Task A provides data to a task B, which processes the data and provides the result to a task C. The tasks communicate their data through FIFO buffers, having a depth of 3 cycles in this example.

The conditions for execution of these tasks are as follows. Task A can only execute if the first buffer is not full. Task B can only execute if the first buffer is not empty and the second buffer is not full. Task C can only execute if the second buffer is not empty.

FIG. 2 is a graph showing the dependencies between occurrences of tasks A, B and C. The rows correspond to tasks A, B and C. Consecutive circles in a row correspond to consecutive occurrences of the same task, indicated within the circles. The columns correspond to consecutive execution cycles, assuming, for sake of simplicity, that each occurrence of a task is completed in one cycle.

Arrows connect dependent occurrences. Each arrow means “must occur before”. In other words, in the graph as shown, each arrow should point to the right, it cannot point to the left or be vertical. The solid arrows represent dependencies imposed by the order of execution of the tasks. Dotted arrows correspond to the dependencies imposed by the (limited) depth of the buffers.

Since the first occurrence of task A is to be executed before the first occurrence of task B, and that this must happen before the first occurrence of task C, the occurrences are offset by one cycle from one row to next.

FIG. 3 shows the graph of FIG. 2, where each occurrence of a task is labeled by a logical time vector according to the method described here. A logical time vector is associated with each task, and updated at the end of each occurrence of the task. As updates of these vectors correspond to increments, these vectors may also be referred to as “logical clocks”, denoted H.

For sake of clarity, the simplest case to understand is described, where each vector or clock H includes a component associated with each task executable on a multi-task system. There are techniques, in conventional use cases of logical time vectors, for optimizing the number of components compared to the number of tasks—such techniques are also applicable here. An example of such a technique is described in “An offline algorithm for dimension-bound analysis” by P. A. S. Ward (Proceeding of the 1999 IEEE International Conference on Parallel Processing, pages 128-136).

Thus, in FIG. 3, there are three vectors H(A), H(B) and H(C) respectively assigned to tasks A, B and C, and each vector has three components respectively assigned to tasks A, B and C.

A component hᵢ associated with a task Tᵢ of a vector H(Tⱼ) associated with a task Tⱼ contains, for example, the occurrence of the task Tᵢ necessary for the execution of the current occurrence of the task Tⱼ. By extension, the component hⱼ associated with the task Tⱼ contains the occurrence of the currently executing task Tⱼ. A null component indicates that the current occurrence of the task associated with the vector does not depend on the task associated with the null component.

For example, as identified in FIG. 3 for an execution cycle t7, the first component of the vector H(A), corresponding to the task A, contains 7, which is the current occurrence of task A. This occurrence of task A requires that the first buffer (FIG. 1) has at least one available location, i.e. that the fourth occurrence of task B has consumed data from the memory buffer; the component (the second) associated with task B in vector H(A) contains 4. The fourth occurrence of task B requires that the second buffer has at least one location, i.e. that the first occurrence of task C has consumed data from this buffer; the component (the third) associated with task C in vector H(A) contains 1.

Each vector is constructed from the graph by following backwards the arrows from the considered occurrence to the nearest occurrence of each of the other tasks. Thus, vector H(B) contains (6, 6, 3) at time t7, and vector H(C) contains (5, 5, 5). If there is no such arrow to follow back, the component is null, which is the case for the first occurrence of tasks A and B.

The construction of the vectors is simple to perform at the execution of an application program implementing the tasks. It appears that, beyond a given occurrence (the sixth for task A, the third for task B, and the first for task C), each component is systematically incremented at each execution of the associated task. It is sufficient to define in advance the initial values and update conditions of the vectors, which can be done by the compiler, as a function of the type of graph describing the task dependencies. These conditions are expressed in the form “increment component xᵢ of vector X starting from the k-th occurrence”. The vectors are stored in shared memory and updated by a scheduler with which each task is registered by the application.

For example, the initial values and update conditions of vector H(A) in FIG. 3 may be defined as follows:

$${H}_{0} ( A ) = \vert \begin{matrix}1 & \\ 0 & {H}_{+ 1} ( A ) = \\ 0 & \end{matrix} \vert \begin{matrix}{a}_{0} := {a}_{0} + 1 \\ {a}_{1} := {a}_{1} + 1 if {a}_{0} > 3 \\ {a}_{2} := {a}_{2} + 1 if {a}_{0} > 6\end{matrix}$$

Now, to exploit such logical time vectors, a partial order relation is defined on the set of these vectors. The partial order relation between two vectors X(x₀, x₂, . . . xₙ) and Y(y₀, . . . yₙ) is defined as:
X<Y is true if and only if: whatever i between 0 and n, xᵢ≦yᵢ and there exists j between 0 and n such that xⱼ<yⱼ.

This order relation is called “partial” because it does not order all vectors. In some cases, the vectors X and Y are not comparable, which is denoted by X∥Y.

Consider now a task Ta awaiting execution, and a need to determine at a current time if this task can be executed. For this determination, the current vector of task Ta is compared to each of the current vectors of the other tasks. Task Ta can be executed only if, whatever other task T, the following condition is met:
H(Ta)<H(T) or H(Ta)∥H(T),
condition that will also be noted [symbol] H(Ta)>H(T).

If at least one other task T yields H(Ta)>H(T), all the conditions are not met for executing task Ta, so task Ta should wait.

In the graph of FIG. 3, which corresponds to a simplistic case, it appears that the vectors in each column from the third are incomparable by pairs. This means that each of the corresponding tasks can be executed in parallel.

The first column produces H(C)>H(B)>H(A), meaning that only task A can be executed.

The second column produces H(C)>H(B), H(B)∥H(A) and H(A)∥H(C), meaning that tasks A and B can be executed in parallel, but that task C must wait.

In a more realistic situation, tasks arrive with more or less delay and they take more or less time to execute.

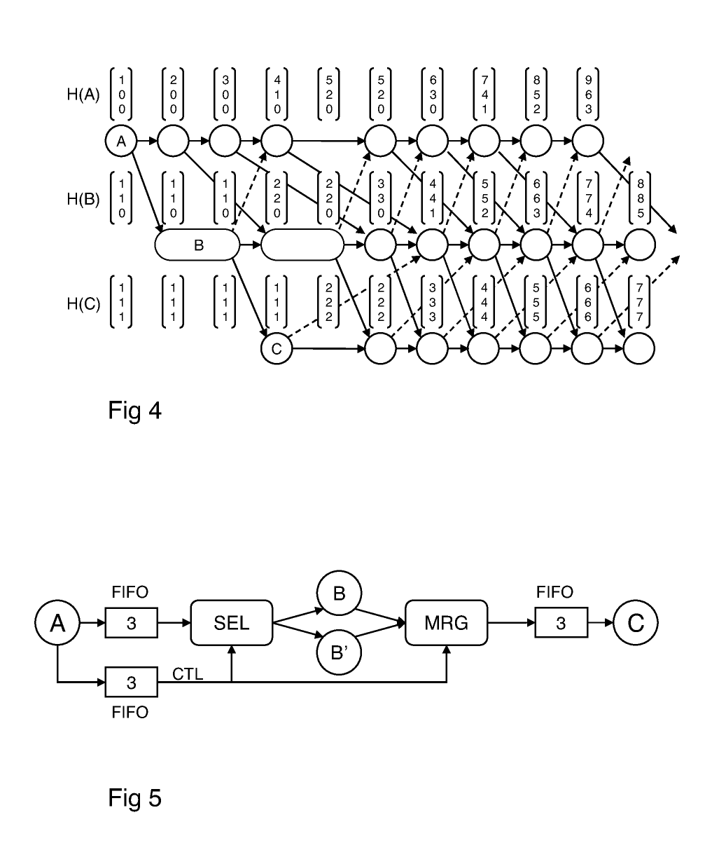

FIG. 4 shows the graph of FIG. 3 modified to illustrate a situation closer to reality. The first two occurrences of task B last twice as long as the other occurrences. It follows that:
the first occurrence of task C starts with one cycle of delay,
the second occurrence of task C starts with two cycles of delay, and
the fifth occurrence of task A starts with one cycle of delay.

The logical time vector of a task remains unchanged over the number of cycles required for the execution of the associated task, which can be seen for the first two occurrences of task B. A vector is updated when the task ends. Thus, as seen for tasks A and B in the fifth column, the new value of the vector is in force at the end of the associated task, and unchanged while waiting for a new occurrence of the task (this is also the case while waiting for the execution of the first occurrence of tasks B and C).

The use of logical time vectors will be better understood with this graph. The third column produces H(C)>H(B). So, unlike the case of FIG. 3, task C cannot yet start. Task C can start in the fourth column, where the vectors become incomparable by pairs.

The fifth column produces H(A)>H(B) and H(C)>H(B). Thus, tasks A and C must wait while task B executes. Tasks A and C may be executed in the sixth column, where the vectors become incomparable by pairs.

It is apparent that the graph may thus extend to infinity, and therefore accommodate occurrences of any length with any delay. This guarantees the absence of deadlocks.

As previously mentioned, the logical time vectors are updated by systematic increments of the components. It is not conceivable in practice that the components tend to infinity. Preferably a component folding mechanism is provided based on a partial order adapted to a subset of the integers. The components of the vectors are thus defined modulo M, and the partial order relation between two vectors (x₀, x₂, . . . xₙ) and y (y₀, y₁, . . . yₙ) is defined as:
X<Y is true if and only if:
   whatever i, xᵢ=yᵢ or xᵢ⊂ yᵢ and there exists j such that xⱼ ⊂ yⱼ,
the relation x ⊂ y being true if and only if:

x<y and y−x≦S, or

x>y and M−x+y≦S.

M and S are integers such that 2S<M, and M is greater than the maximum offset between components of a vector. In the case of FIG. 3, the maximum offset is 6, for vector H(A) from the seventh occurrence. This maximum offset is determined from the moment when all initial conditions are taken into account, i.e. from the moment all components of all vectors are incremented.

In the example of FIG. 3, with M=8 and N=3, the components of the vectors are folded from value 7. The last two vectors of the graph for task A are thus expressed by (0, 5, 2) and (1, 6, 3), and the last vector of the graph for task B is expressed by (0, 0, 5).

Placing the eight possible values of each component on a circle, the comparison of the components by the “smaller than” relation ⊂ defined above is such that a value x is smaller than each of the 3 (S) following values, and greater than each of the four (M−S−1) previous values on the circle. We have for example:
1 ⊂ 2; 1 ⊂ 3; 1 ⊂ 4; and
4 ⊂ 1; 5 ⊂ 1; 6 ⊂ 1; 7 ⊂ 1.

According to the methodology described above, at each execution cycle, the logical time vector of each task is compared to each of the vectors of the other tasks, to determine whether the task can be executed. This represents significant computational resources if the number of tasks grows: the number of comparisons increases quadratically with the number of tasks. In addition, even if the result of the comparisons indicates that a task may be executed, it is possible that the task cannot be executed immediately given the available computing resources (in this situation, the task is so-called executable). It may therefore be necessary to manage a list of executable tasks.

To reduce the computational resources, and facilitate the planning of executable tasks, a dependency counter is associated to each task, denoted K, whose content is representative of the number of conditions to be met before the task becomes executable. In practice, the content of the counter may be equal to the number of conditions still unmet, and, when the content becomes zero, the task becomes executable.

To update the dependency counters, the following procedure may be applied.

At system initialization:
H(T):=H₀(T) and K(T):=0, where H₀(T) is a starting vector for task T, e.g. (1, 0, 0) for task A, (1, 1, 0) for task B, and (1, 1, 1) for task C, in the case of FIG. 3.

Then the scheduler process observes the contents of the dependency counters and starts the execution of each task for which the counter is zero, or plans the execution of these tasks if the resources are insufficient to execute them in parallel.

Whenever a task T ends, the following four steps are performed atomically, i.e. before a new occurrence of a task is executed:

For each other task Ta having H(Ta)>H(T), perform K(Ta):=K(Ta)−1. In other words, the task T that has just ended fulfills one of the conditions for each of these tasks Ta to become executable.

Update vector H(T) for the new occurrence of task T. As previously mentioned, this can be achieved by incrementing each component of the vector when the number of occurrences reaches a threshold value set for the component in the initial conditions.

For each other task Ta having H(T)>H(Ta), perform K(T):=K(T)+1. In other words, all the conditions for the execution of the new occurrence of task T are identified, and they are accounted for in the dependency counter of task T.

For each other task Ta having H(Ta)>H(T), perform K(Ta):=K(Ta)+1. In other words, the new conditions created by the new occurrence of task T are identified for the other tasks Ta, and they are accounted for in the dependency counters of these other tasks.

The dependency counters may be realized in hardware and monitored in parallel by a null content detection circuit. The logical time vectors may be stored in dedicated registers coupled to hardware comparators, configured to increment and decrement the counters according to the above rules. (Of course, sufficient hardware counters and registers dedicated to the vectors would be provided to cope with the number of distinct tasks included in the applications to be run on the system.) In this case, the system software (the scheduler) is responsible only for updating the vectors in the dedicated registers, the comparisons and updates of the counters being performed through hardware acceleration.

The dependency counters are indicators of imminent execution; they may therefore be used to control data prefetching operations, for example. In addition, it appears that the number of comparisons increases linearly with the number of tasks.

FIG. 5 shows a more complex example of sequence of tasks in a dataflow process, with two alternative task executions. Task B of FIG. 1 comprises two tasks here, B and B′, one of which is selected for execution when task A ends. Each data word generated by an occurrence of task A is routed through a selection element SEL to one of the tasks B and B′. The selection is operated by a control word CTL also produced by task A, and pushed in a FIFO of same depth as the FIFOs arranged between the tasks A, B and C. This control word CTL is taken into account at the same time by a merge element MRG that chooses, for provision to task C, the output of the active task B or B′.

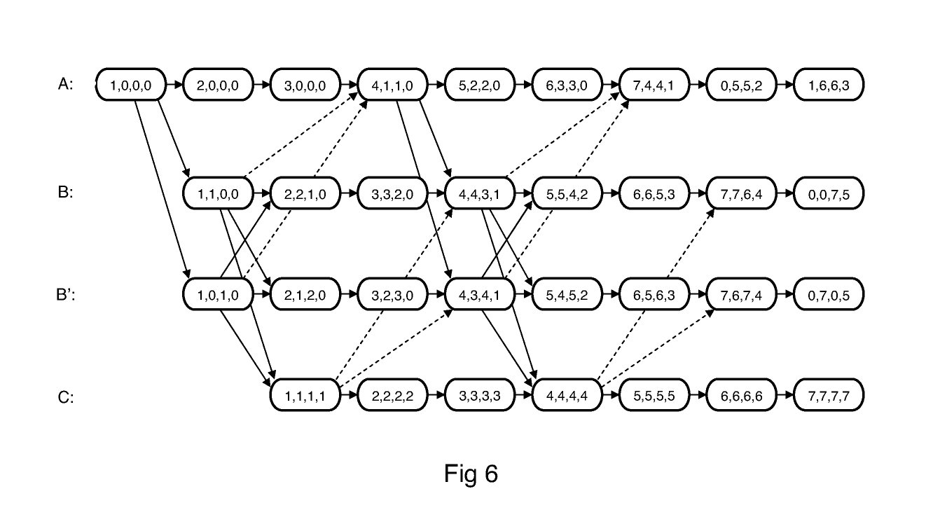

FIG. 6 is a dependency graph corresponding to the case of FIG. 5, assuming that the occurrences of tasks have the same length and have no delay (as the graph of FIG. 3). The logical time vector values are indicated inside the nodes representing occurrences. The vectors here have four components. In addition, the folded vector notation is used, with components defined modulo 8.

For reasons of clarity, not all dependency arrows are shown. Only the arrows from the first and fourth occurrences of each task are shown, knowing that the other arrow sets are copies from one occurrence to the next. Dependencies are built in the same way as for the graph of FIG. 3, considering that an arrow arriving at, or departing from an occurrence of task B in FIG. 3 is duplicated here for each of tasks B and B′. Moreover, an arrow departs from each occurrence of task B to the next occurrence of task B′, and an arrow departs from each occurrence of task B′ to the next occurrence of task B.

A specificity of the flow of FIG. 5 is that only one of tasks B and B′ is executed between tasks A and C. To take this into account in the methodology described above, it is assumed that both tasks B and B′ are executed at the same time each time one of these two tasks is executed. In other words, at each execution of task B or B′, the vectors of both tasks are updated and, when using dependency counters K, the counters of both tasks are updated similarly.

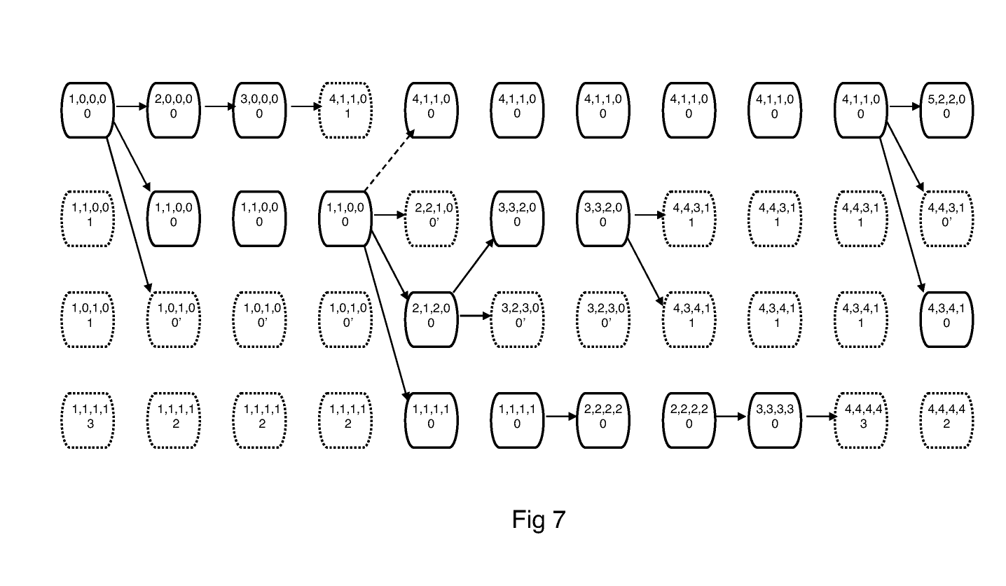

FIG. 7 shows an exemplary execution trace of a processing according to the graph of FIG. 6. The solid nodes correspond to task occurrences that are being executed or have been executed. Dotted nodes correspond to occurrences awaiting execution. Dependency arrows only appear at the end of the execution of an occurrence, that is to say, when the vectors H and counters K are computed. Each node contains the corresponding values of the logical time vector and dependency counter K, whose values are updated through the four atomic steps described above.

For determining the initial values of counters K of tasks A, B, B′, and C, it is assumed that each task has been completed and that the vector H has been updated to its initial value. In applying counter update step 3 to each task, the counters are initialized to 0, 1, 1, and 3, respectively.

At startup, three occurrences of task A are executed over three consecutive cycles. The first of these occurrences starts the first occurrence of task B that takes three cycles to complete. It is considered, from the point of view of its vector and dependency counter, that the first occurrence of task B′ proceeds at the same time as the first occurrence of task B.

The fourth occurrence of task A, the second occurrence of task B/B′, in fact B′, and the first occurrence of task C can start at the fifth cycle. Considering that tasks B and B′ end at the same time in the fourth cycle, counter K of task C in the fifth cycle is decremented by 2, by applying twice counter update step 1, once for task B, and once for task B′.

The fourth occurrence of task A takes 6 cycles, the second occurrence of task B′ takes one cycle and the first occurrence of task C takes two cycles.

In the eighth cycle, while the fourth occurrence of task A is still ongoing, the third occurrence of task B/B′ (in fact B) ends and the second occurrence of task C is started. The fourth occurrence of task B/B′ (in fact B′) waits for the eleventh cycle, where the fourth occurrence of task A will complete.

In the examples of task executions described so far, the use of the counter update step 4 has not been revealed.

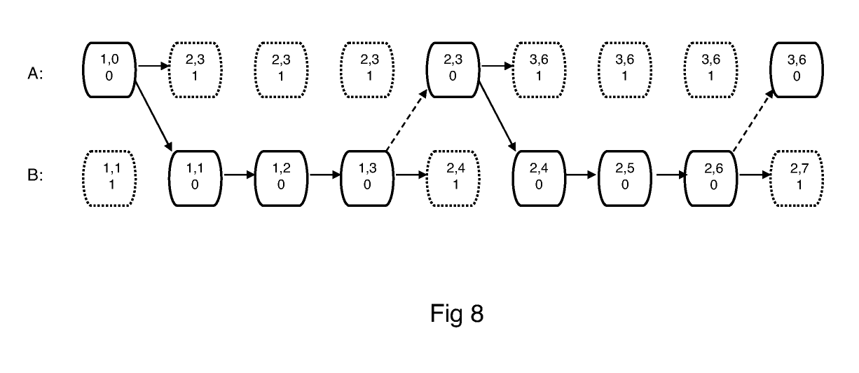

FIG. 8 is a trace of a simple example of execution of two tasks A and B where step 4 is useful. The same representation conventions as in FIG. 7 are used. Each occurrence of a task A produces three data words, each of which is consumed by a distinct occurrence of task B. It is also assumed that the FIFO between tasks A and B has a depth of three data words—it follows that each occurrence of task A takes all available space in the FIFO. Thus, a second occurrence of task A cannot start until the third occurrence of task B eventually releases space in the FIFO.

Note here that the second component of vector H(A) is incremented by 3 at each execution of an occurrence of task A, because starting an occurrence of task A is subject to the execution of three consecutive occurrences of task B. Note also that the first component of vector H(B) is incremented after every third execution of an occurrence of task B. This reflects that three consecutive occurrences of task B are subject to a same occurrence of task A.

Applying the four dependency counter update steps at the end of the first occurrence of task B produces, with T=B and Ta=A:

H(A)=(2, 3)>H(B)=(1, 1)=>K(A):=K(A)−1=0 ;
H(B):=(1, 2) ;
H(B)>H(A) is false. K(B) remains unchanged;

H(A)=(2, 3)>H(B)=(1, 2)=>K(A):=K(A)+1=1. The original, correct, value of K(A) is restored, which was temporarily changed in step 1.

These four steps are carried out atomically so that the transient value of K from step 1 is restored to its original value in step 4 and does not affect the list of ready tasks.

At each of the counter update steps 1, 3 and 4, N-1 logical time vector comparisons are carried out, where N is the number of tasks, and each vector comparison requires comparing two by two up to N vector components. The number of component comparisons thus grows quadratically with the number of tasks. These operations may be performed in software by the scheduler process, but it would be desirable to provide hardware support for this to spare software resources.

The comparison operation using a partial order, and the components being bounded with folding in a preferred embodiment, conventional digital comparators are not suitable.

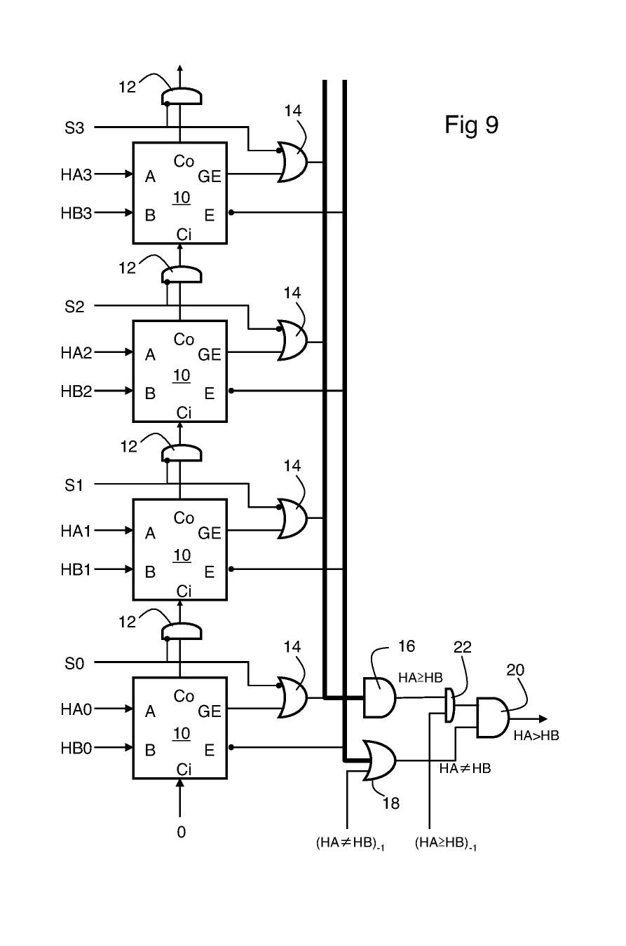

FIG. 9 shows first repetitive elements of an embodiment of a comparator for logical time vectors HA and HB, which may satisfy these needs.

It is assumed that a logical time vector is defined on a bounded number Nv of bits, for example 64, and that each component of this vector can be defined on a programmable number of bits, multiple of a minimum number Nm, for example 4. This number Nm determines the maximum number of components of a vector. Thus, with a vector of 64 bits and a minimum number of 4 bits per component, one can define at most 16 components of 4 bits, and any combination having fewer components defined with multiples of 4 bits.

The comparator of FIG. 9 includes a series of comparator units 10 connected in a chain. Each unit 10 processes two 4-bit components to compare from two vectors HA and HB. Each unit 10 may be related, in terms of its external terminals, to a comparator based on a subtractor summing its input A and the two's complement (˜B+1) of its input B. Thus, the unit 10 includes, in addition to an input for each of the components to be compared, a carry input Ci, a carry output Co, an output E indicating whether A=B, and an output GE indicating whether A≧B.

As a first approach, to simplify the description, consider that the units 10 are conventional comparators. As discussed further below, the logical table of the units will be modified for comparing folded values.

The units 10 are chained by their carry outputs and inputs Co and Ci, so as to construct a comparator of two 64-bit words. The boundaries between the vector components are defined using AND gates 12, a gate 12 being arranged between each carry output Co of a unit and the carry input Ci of the next unit. The carry input of the first unit receives 0 (no carry to take into account).

Each gate 12 is controlled by a respective signal S (S0, S1, S2 . . . ) whose active state (1) determines a boundary between components. The active state of signal S blocks the gate 12, whereby the carry of the corresponding unit 10 is not transmitted to the next unit, and the next unit does not propagate the comparison—the next unit thus performs an independent comparison.

An inactive signal S (0) opens gate 12 and causes the chaining of two units 10 by allowing carry propagation. These two units are thus associated with a same vector component.

In the representation of FIG. 9, if the four signals S are inactive, four units 10 are associated with a single 16-bit component. If the signals S1 and S3 are active, the units are associated with two distinct 8-bit components. If all the signals S are active, each unit is associated with a distinct 4-bit component.

In addition, each signal S is applied to an inverted input of a corresponding OR gate 14, a second input of the OR gate receiving the output GE of corresponding unit 10. When the signal S is inactive, the gate 14 does not propagate the output GE of the unit—this output corresponds to an intermediate comparison result that may be ignored. Only a unit whose signal S is active sees its output GE propagated by the corresponding gate 14—this output consolidates the comparison results produced by the current unit and the preceding chained units (units whose signal S is inactive).

The outputs of gates 14 arrive at an AND gate 16, whose output is therefore active if the outputs GE of all units 10 are active, that is to say, if each component of vector HA is greater than or equal to the corresponding component of vector HB (HA≧HB). (The outputs of gates 14 blocked by a signal S=0 are in fact at “1”, so they do not affect the outputs of the other gates 14.)

The outputs E of the units 10, inverted, arrive at an OR gate 18. Thus, the output of gate 18 becomes active if at least one of the outputs E is inactive, that is to say if there is an inequality for at least one pair of components of vectors HA and HB (HA≠HB).

The outputs of gates 16 and 18 arrive at an AND gate 20. Thus, gate 20 provides an active signal (HA>HB) if all the components of vector HA are greater than or equal to their respective components of vector HB (gate 16 active), and at least two respective components of vectors HA and HB are unequal (so one is strictly greater than the other). A vector comparison is thus obtained according to a partial order relation.

The manner by which units 10 compare folded components remains to be defined. The outputs of each unit 10, in connection with the example where a unit processes 4-bit words A and B, may be defined as follows:

Co=1 if A+˜B+Ci>15 (=2⁴−1). This corresponds to the conventional definition of a carry bit in an adder used to make a comparison.
E=1 if A=B.
GE=1 if A⊃ B, where ⊃ is the order relation “greater than or equal” according to the definition previously given for operating on values that are folded modulo M (M=16 here).

The table below provides, for one example of folding, the values of output GE based on all possible values of A and B, indicated in decimal.

| | B | | | | | | | | | | | | | | | |
|---|---|---|---|---|---|---|---|---|---|---|---|---|---|---|---|---|
| A | 0 | 1 | 2 | 3 | 4 | 5 | 6 | 7 | 8 | 9 | 10 | 11 | 12 | 13 | 14 | 15 |
| 0 | 1 | 0 | 0 | 0 | 0 | 0 | 0 | 0 | 0 | 1 | 1 | 1 | 1 | 1 | 1 | 1 |
| 1 | 1 | 1 | 0 | 0 | 0 | 0 | 0 | 0 | 0 | 0 | 1 | 1 | 1 | 1 | 1 | 1 |
| 2 | 1 | 1 | 1 | 0 | 0 | 0 | 0 | 0 | 0 | 0 | 0 | 1 | 1 | 1 | 1 | 1 |
| 3 | 1 | 1 | 1 | 1 | 0 | 0 | 0 | 0 | 0 | 0 | 0 | 0 | 1 | 1 | 1 | 1 |
| 4 | 1 | 1 | 1 | 1 | 1 | 0 | 0 | 0 | 0 | 0 | 0 | 0 | 0 | 1 | 1 | 1 |
| 5 | 1 | 1 | 1 | 1 | 1 | 1 | 0 | 0 | 0 | 0 | 0 | 0 | 0 | 0 | 1 | 1 |
| 6 | 1 | 1 | 1 | 1 | 1 | 1 | 1 | 0 | 0 | 0 | 0 | 0 | 0 | 0 | 0 | 1 |
| 7 | 1 | 1 | 1 | 1 | 1 | 1 | 1 | 1 | 0 | 0 | 0 | 0 | 0 | 0 | 0 | 0 |
| 8 | 0 | 1 | 1 | 1 | 1 | 1 | 1 | 1 | 1 | 0 | 0 | 0 | 0 | 0 | 0 | 0 |
| 9 | 0 | 0 | 1 | 1 | 1 | 1 | 1 | 1 | 1 | 1 | 0 | 0 | 0 | 0 | 0 | 0 |
| 10 | 0 | 0 | 0 | 1 | 1 | 1 | 1 | 1 | 1 | 1 | 1 | 0 | 0 | 0 | 0 | 0 |
| 11 | 0 | 0 | 0 | 0 | 1 | 1 | 1 | 1 | 1 | 1 | 1 | 1 | 0 | 0 | 0 | 0 |
| 12 | 0 | 0 | 0 | 0 | 0 | 1 | 1 | 1 | 1 | 1 | 1 | 1 | 1 | 0 | 0 | 0 |
| 13 | 0 | 0 | 0 | 0 | 0 | 0 | 1 | 1 | 1 | 1 | 1 | 1 | 1 | 1 | 0 | 0 |
| 14 | 0 | 0 | 0 | 0 | 0 | 0 | 0 | 1 | 1 | 1 | 1 | 1 | 1 | 1 | 1 | 0 |
| 15 | 0 | 0 | 0 | 0 | 0 | 0 | 0 | 0 | 1 | 1 | 1 | 1 | 1 | 1 | 1 | 1 |

In a conventional comparator, the values located below the descending diagonal, including the values on the diagonal, are all 1, and the values located above the diagonal are all 0. In the comparator used here, as shown in bold, the lower left corner, bounded between (A, B)=(8, 0) and (15, 7) contains only zeros, and the upper right corner bound between (A, B)=(0, 9) and (6, 15) contains only ones. Expressed otherwise, each row comprises eight consecutive zeros, following the value 1 of the diagonal, followed by eight consecutive ones, the pattern of values being such that it fills the row circularly.

This example corresponds to S=7 (8−1) in the general definition of the partial order relation between folded values (where 2S<M). Decreasing the value of S reduces the number of consecutive zeros in the rows, and increases the number of ones. For example, S=5 produces 6 consecutive zeros and 10 consecutive ones in each row.

If n units 10 are chained to match a 4n-bit component, although each unit 10 operates independently on 4 bits, and hence values bounded to 15, all units chained together operate on 4n-bit values bounded to 2⁴ⁿ−1, thanks to the carry propagation.

If the number of components of the vectors is greater than the capacity of the comparator, it is nevertheless possible to perform a comparison using the comparator in several cycles, with a few additional elements, in the following manner.

During a first cycle, a first set of components is compared. The output of gate 20 is ignored and the states of the outputs of gates 16 and 18 are stored for the next cycle, for instance in flip-flops.

In the next cycle, a new set of components is presented to the comparator. The OR gate 18 receives, as an additional input, the previously stored state (HA≠HB)₋₁ of its output. Thus, if an inequality was detected in the previous cycle, this detection is imposed on the current cycle. Furthermore, an additional AND gate 22 is interposed between gates 16 and 20. The output of the gate 22 is active only if the output of gate 16 and the previously stored state (HA≧HB)₋₁ of this output are active.

The output of gate 20 will be taken into account after a sufficient number of cycles to process all the components with the comparator.

Although the above description refers to a state “1” as an active state, and a state “0” as an inactive state, it is understood that the nature of these states may be exchanged by adapting the logic circuits without changing the result.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-3. (canceled)

4. A comparator unit (10) for two Nm-bit data words (A, B), comprising a comparison output (GE) indicative of an order relation between the two data words, the function of the comparison unit being represented by a logic table comprising rows associated with possible consecutive values of the first data word (A) and columns associated with possible consecutive values of the second data word (B), where each row includes a one at an intersection with the column associated with the same value as the row, followed by a series of zeros, wherein said series of zeros is followed by a series of ones completing the row circularly, the number of zeros being the same for each row and smaller than half of a maximum value (15) of the data words.

5. A comparator for two vectors according to a partial order relation, wherein each vector comprises components having a number of bits that is a multiple of Nm, comprising:
a plurality of comparator units (10) according to claim 1, connected in a chain through carry propagation terminals (Co, Ci);
a gate (12) arranged between the carry propagation terminals of two consecutive units, configured to interrupt the carry propagation between said consecutive units in response to an active state (1) of a signal (S) defining a boundary between vector components; and
a gate (14) arranged at the comparison output (GE), configured for inhibiting the state of the comparison output in response to an inactive state (0) of the boundary definition signal (S).

6. The comparator of claim 2, wherein each unit (10) comprises an equality output (E) indicative of the equality of the data words presented to the unit, and the comparator comprises logic configured to establish an active indication if and only if all comparison outputs (GE) of the units are active and the equality output (E) of at least one unit is inactive.
